(19) United States
(12) Patent Application Publication
(10) Pub. No.: US 2025/0329193 A1
(43) Pub. Date: Oct. 23, 2025

(54) INFORMATION PROCESSING APPARATUS, INFORMATION PROCESSING METHOD, AND STORAGE MEDIUM

(71) Applicant: NEC Corporation, Tokyo (JP)

(72) Inventors: Yoshitaka NOZAKI, Tokyo (JP); Kosuke Nishihara, Tokyo (JP); Kensuke Wagata, Tokyo (JP); Kentaro Nakahara, Tokyo (JP)

(73) Assignee: NEC Corporation, Tokyo (JP)

(21) Appl. No.: 19/096,889

(22) Filed: Apr. 1, 2025

(30) Foreign Application Priority Data
Apr. 23, 2024 (JP) 2024-069919

(51) Int. Cl. G06V 40/20

(52) U.S. Cl. CPC G06V 40/20

(57) ABSTRACT

A motion recognition device of the present disclosure includes a transforming unit that transforms first motion data into a first symbol string including a sequence of symbols; a recognizing unit that recognizes the motion of the first motion data based on the first symbol string; and a deforming unit that generates a third symbol string in which the first symbol string is deformed based on a second symbol string. The second symbol string is a sequence in which second motion data corresponding to the motion recognized in the first motion data is transformed into a sequence of symbols. Consequently, a motion recognition model can be machine-learned using the generated third symbol string for example, and decision making based on the recognized motion can be supported.

### INCORPORATION BY REFERENCE

This application is based upon and claims the benefit of priority from Japanese patent application No. 2024-069919, filed on Apr. 23, 2024, the disclosure of which is incorporated herein in its entirety by reference.

### TECHNICAL FIELD

The present disclosure relates to an information processing apparatus, an information processing method, and a storage medium.

### BACKGROUND ART

Patent Literature 1 describes recognizing a motion of a person from video. To be specific, in Patent Literature 1, a basic motion of a person is recognized from the skeleton information of the person in each frame of the video, and a higher-level motion consisting of a combination of basic motions is recognized. In that case, for example, raising a hand, looking down, and the like are mentioned as basic motions, and working behavior and suspicious behavior are mentioned as higher-level motions.
Patent Literature 1: JP 2022-3434 A

### SUMMARY

However, the technology described in Patent Literature 1 requires a large amount of training data for the higher-level motions. Therefore, it is difficult to prepare a large amount of training data for higher-level motions that are unique depending on the location and environment, so that it is impossible to recognize new higher-level motions. As a result, there arises a problem that motions of a person cannot be recognized properly.

Therefore, an exemplary object of the present disclosure is to solve the abovementioned problem of not being able to properly recognize a motion of a person.

An information processing apparatus, according to one aspect of the present disclosure, is configured to include
a transforming unit that transforms first motion data into a first symbol string including a sequence of symbols,
a recognizing unit that recognizes the motion of the first motion data based on the first symbol string, and
a deforming unit that generates a third symbol string in which the first symbol string is deformed based on a second symbol string, the second symbol string being a string in which second motion data corresponding to the motion recognized in the first motion data is transformed into a sequence of symbols.

Further, an information processing method according to one aspect of the present disclosure is configured to include
transforming first motion data into a first symbol string including a sequence of symbols,
recognizing the motion of the first motion data based on the first symbol string, and
generating a third symbol string in which the first symbol string is deformed based on a second symbol string, the second symbol string being a string in which second motion data corresponding to the motion recognized in the first motion data is transformed into a sequence of symbols.

Further, a program according to one aspect of the present disclosure is configured to cause a computer to execute processing to
transform first motion data into a first symbol string including a sequence of symbols,
recognize the motion of the first motion data based on the first symbol string, and
generate a third symbol string in which the first symbol string is deformed based on a second symbol string, the second symbol string being a string in which second motion data corresponding to the motion recognized in the first motion data is transformed into a sequence of symbols.

With the configurations as described above, the present disclosure can appropriately recognize a motion of a person.

### BRIEF DESCRIPTION OF THE DRAWINGS

FIG. 1 is a block diagram illustrating an example configuration of a data augmentation apparatus according to the present disclosure;

FIG. 2 illustrates an example of data related to the present disclosure;

FIG. 3 illustrates an example of data related to the present disclosure;

FIG. 4 illustrates an example of processing of a data augmentation apparatus according to the present disclosure;

FIG. 5 is a flowchart illustrating an example of processing operation of the data augmentation apparatus according to the present disclosure;

FIG. 6 is a block diagram illustrating an example of a hardware configuration of an information processing apparatus according to the present disclosure; and

FIG. 7 is a block diagram illustrating an example configuration of the information processing apparatus according to the present disclosure.

### EXEMPLARY EMBODIMENT

### First Example Embodiment

A first example embodiment of the present disclosure will be described with reference to the drawings. Note that the drawings may be related in any embodiments.

### [Configuration]

A data augmentation apparatus 10 of the present disclosure is used to, for example, generate training data to be used when machine-learning a motion recognition model that recognizes a motion of a person from motion data of a person. To be specific, in the present embodiment, it is assumed that a basic motion is recognized from motion data of a person, and a higher-level motion is recognized from a combination of such basic motions. In particular, it is assumed that a higher-level motion is recognized using a motion recognition model from a combination of basic motions. The motion recognition model is generated by machine-learning the training data in which a combination of basic motions and a higher-level motion are associated with each other in advance. A combination of basic motions constituting such training data is generated by the data augmentation apparatus 10 of the present disclosure.

However, the data generated by the data augmentation apparatus 10 of the present disclosure is not necessarily limited to be used as training data for machine-learning the motion recognition model as described above, and may be used for any purpose.

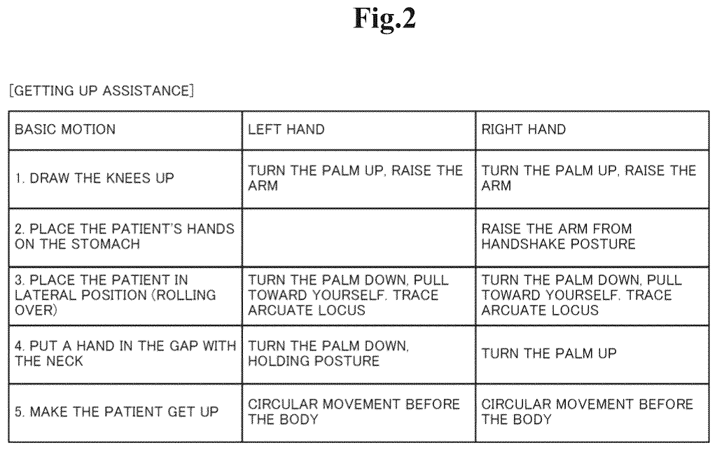

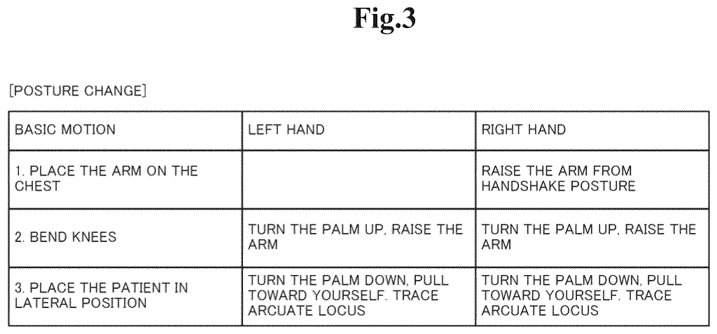

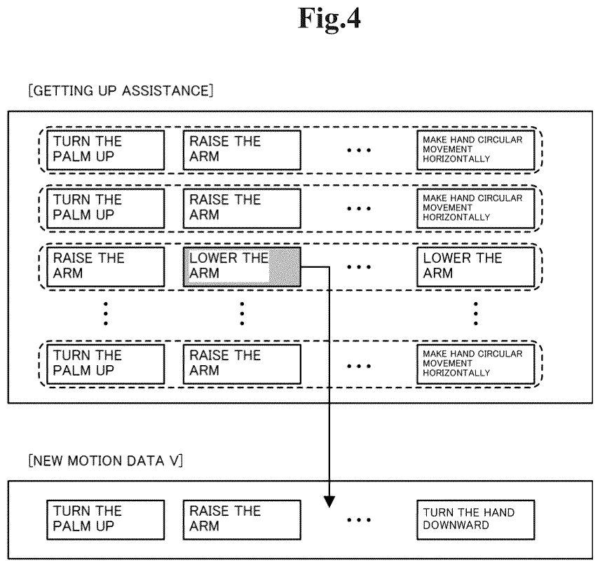

Here, a specific example of motion recognition assumed in the present embodiment will be described. First, higher-level motions of a person to be a recognition target in the motion recognition include, for example, a nursing motion by a nurse for a patient. Examples of such nursing motion include “getting up assistance” and “posture change”. Then, as a combination of basic motions consisting a higher-level motion that is “getting up assistance”, as illustrated in FIG. 2, “1. Draw the knees up” “2. Place the patient's hands on the stomach” “3. Place the patient in a lateral position (rolling over)” “4. Put a hand in the gap with the neck” and “5. Make the patient get up” can be listed in order. At this time, “left hand” and “right hand” motions as shown in FIG. 4 are specified as the basic motions of further specific person's parts corresponding to each basic motion. Further, as illustrated in FIG. 3, as basic motions consisting the “postural change” that is a higher-level motion, “1. Place the arm on the chest,” “2. Bend knees,” and “3. Place the patient in a lateral position” can be listed in order. At this time, “left hand” and “right hand” motions as illustrated in FIG. 3 are specified as basic motions of further specific person's parts corresponding to each basic motion.

In the situation described above, at the time of motion recognition, a combination of a series of basic motions in chronological order is first recognized from the motion data of a person. Then, a higher-level motion is recognized from the combination of the recognized basic motions. FIG. 4 illustrates an example of a combination of basic motions corresponding to a higher-level motion. The upper drawing of FIG. 4 illustrates combinations of a series of basic motions corresponding to a higher-level motion “getting up assistance” surrounded by dotted lines. In this example, basic motions are represented by “text” such as “turn the palm up”, and such “text” will be referred to as a “motion word” in this example, and a sequence of combinations of a series of “motion words” will be referred to as a “motion word string”. That is to say, as will be described below, the present embodiment will describe recognizing a basic motion as a “motion word” from the motion data of a person and recognizing a higher-level motion from the “motion word string” that is a combination of words consisting of a sequence of such “motion words”, as an example.

In the present embodiment, an example will be given in which a basic motion is represented by a sentence including a plurality of meaningful characters representing the content of a motion referred to as a “motion word”, but the “motion word” is not necessarily limited to being represented by a plurality of meaningful characters representing the content of a motion, and may be represented by a plurality of meaningless characters. In addition, a “motion word” corresponding to a basic motion is not limited to being represented by Japanese characters, and may be represented by a symbol of any notation including letters, numbers, and symbols of any language. Further, a “motion word” is not limited to being represented by a plurality of symbols, and may be represented by a symbol such as one letter.

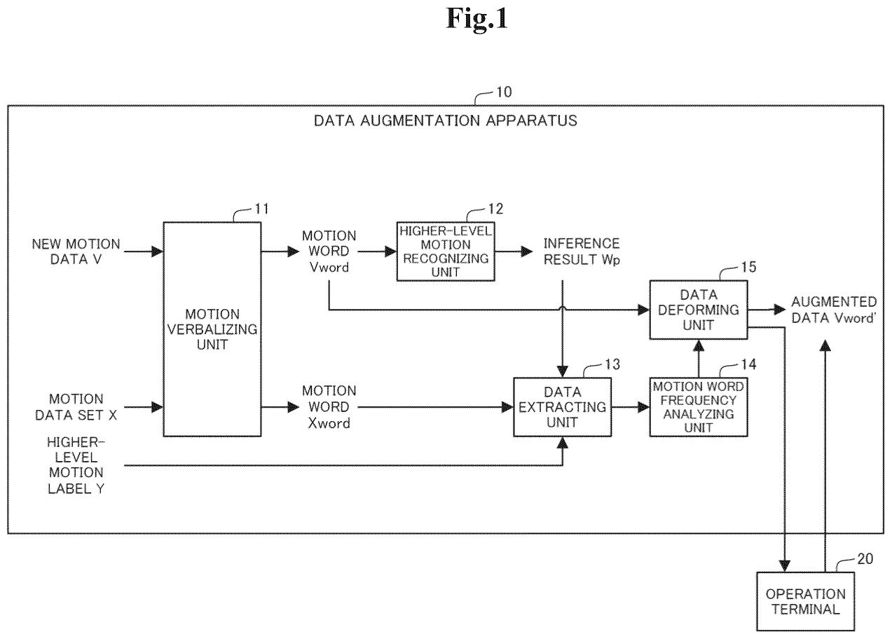

The data augmentation apparatus 10 is configured of one or a plurality of information processing apparatuses each including an arithmetic logic unit and a storage device. As illustrated in FIG. 1, the data augmentation apparatus 10 includes a motion verbalizing unit 11, a higher-level motion recognizing unit 12, a data extracting unit 13, a motion word frequency analyzing unit 14, and a data deforming unit 15. The respective functions of the motion verbalizing unit 11, the higher-level motion recognizing unit 12, the data extracting unit 13, the motion word frequency analyzing unit 14, and the data deforming unit 15 can be realized by the arithmetic logic unit executing a program for realizing the respective functions stored in the storage device. Note that an operation terminal 20 is connected to the data augmentation apparatus 10. The operation terminal 20 is an information processing terminal operated by an operator who checks the data generated by the data augmentation apparatus 10.

To the data augmentation apparatus 10, new motion data V of a person is input. The new motion data V is, for example, data that is not used as training data when the motion recognition model is machine-learned. In the present embodiment, it is assumed that the new motion data V is data corresponding to a higher-level motion “posture change”, as an example. However, the new motion data V may be data having been used at the time of machine-learning the motion recognition model, and in that case, additional machine learning is performed.

At this time, the motion data is, for example, acceleration data of a part of the person's body and, for example, is acceleration data measured by a wearable terminal such as a smartwatch worn on the person's arm. However, the motion data may be any data representing a motion of a person acquired from the person. For example, the motion data may be data such as position, speed, acceleration, and the like of a joint of a person acquired by analyzing the video.

In addition, a motion data set X including a plurality of pieces of motion data of a person and a higher-level motion label Y corresponding to the motion data of the motion data set X are input to the data augmentation apparatus 10. The respective pieces of motion data of the motion data set X and the higher-level motion label Y are, for example, training data having been used at the time of machine-learning the motion recognition model and data having been used to verify the machine-learned motion recognition model. In the present embodiment, it is assumed that the motion data of the motion data set X is data corresponding to the higher-level motion label Y of “getting up assistance”. However, the motion data set X and the higher-level motion label Y are not limited to the training data or validation data of the motion recognition model, and may be any data.

The new motion data V, the motion data set X, and the higher-level motion label Y described above may be stored in the storage device provided by the data augmentation apparatus 10, or may be stored in an external storage device.

The motion verbalizing unit 11 (transforming unit) acquires the time-series new motion data V (first motion data), transforms the motion data of each predetermined unit time into a “motion word” (symbol) representing a basic motion, and outputs a “motion word string Vword” (first symbol string) including a sequence of a series of “motion words” in chronological order. Consequently, for example, as illustrated in the lower drawing in FIG. 4, the motion verbalizing unit 11 can transform the new motion data V into a “motion word string Vword” including a sequence of a series of “motion words” such as [“turn the palm up”, “raise the arm”, . . . ], and output it.

For example, the motion verbalizing unit 11 inputs the new motion data V into the basic motion recognition model that is a machine learning model to transform the new motion data V into the motion word string Vword and output it. The basic motion recognizing model is constructed by, for example, machine-learning training data in which motion data and a “motion word” representing a basic motion corresponding to the motion data are associated with each other. However, the motion verbalizing unit 11 may transform the motion data into a motion word by any method.

Further, the motion verbalizing unit 11 acquires each piece of motion data (second motion data) of the motion data set X, transforms, for each piece of motion data, the motion data of each predetermined unit time into a “motion word” (symbol) representing a basic motion, and outputs a “motion word string Xword” (second symbol string) including a sequence of a series of “motion words” in chronological order. Consequently, for example, as illustrated in the upper drawing of FIG. 4, the motion verbalizing unit 11 can transform each piece of motion data of the motion data set X into the “motion word string Xword” including a sequence of a series of “motion words” such as [“turn the palm up”, “raise the arm”, . . . ], [“raise the arm”, “lower the arm”, . . . ], or the like, and output it. Note that the upper drawing of FIG. 4 illustrates the case of data corresponding to the higher-level motion label Y of “getting up assistance” as a higher-level motion. It is assumed that the motion word string Xword is also output for the motion data set X of another higher-level motion label Y.

Note that the motion verbalizing unit 11 transforms each piece of motion data into the motion word string Xword by inputting each piece of motion data of the motion data set X into the basic motion recognition model that is a machine learning model as described above, and outputs it, for example. At this time, transformation from the motion data set X into the motion word string Xword by the motion verbalizing unit 11 may be performed at any timing, and the motion word string Xword transformed from the motion data set X may be associated with the higher-level motion label Y and stored at the time of machine-learning the motion recognition model.

The higher-level motion recognizing unit 12 (recognizing unit) acquires the motion word string Vword transformed from the new motion data V, and outputs an inference result Wp that recognizes the higher-level motion of the new motion data V from the motion word string Vword. The higher-level motion recognizing unit 12 outputs the higher-level motion label representing the higher-level motion as an inference result. In the present embodiment, for example, in the example of the new motion data V illustrated in the lower drawing of FIG. 4, the new motion data V is actually data corresponding to a higher-level motion “posture change”, but the higher-level motion recognizing unit 12 recognizes it as a higher-level motion “getting up assistance”, and outputs the inference result Wp.

Note that the higher-level motion recognizing unit 12 inputs the motion word string into the motion recognition model that is a machine learning model and outputs the recognized higher-level motion label as the inference result Wp, for example. The motion recognition model is constructed by, for example, machine-learning the training data in which the motion word string and the higher-level motion label are associated with each other. However, the higher-level motion recognizing unit 12 may infer the higher-level motion label from the motion word string by any method.

The data extracting unit 13 (deforming unit) acquires the motion word string Xword of the motion data set X, the higher-level motion label Y corresponding to the motion data set X, and the inference result Wp recognized from the motion word string Vword of the new motion data V Then, the data extracting unit 13 extracts the motion word string Xword of the motion data set X corresponding to a higher-level motion label Y identical to the higher-level motion label that is the inference result Wp of the new motion data V, and outputs it. That is to say, the data extracting unit 13 extracts only the motion word string Xword of the higher-level motion label Y that is determined to be most similar to the new motion data V In the present embodiment, a plurality of motion word strings Xwords corresponding to the higher-level motion label Y of “getting up assistance” illustrated in the upper drawing of FIG. 4 are extracted.

The motion word frequency analyzing unit 14 (deforming unit) acquires the extracted motion word strings Xwords, and compares and analyzes the motion word string Xwords with each other. To be specific, the motion word frequency analyzing unit 14 calculates the appearance position and the appearance frequency, that is, which motion word appears in the motion word string Xword and at which position and how many times, and outputs the distribution of the appearance frequency and the appearance position of each motion word. For example, in the example illustrated in the upper drawing of FIG. 4, it is analyzed that a motion word “raise the arm” appears “n” times in the motion word string Xword at the second position in the chronological order.

Further, the motion word frequency analyzing unit 14 determines whether or not the appearance frequency of a motion word is low, as an example of analysis. Here, it is assumed that low frequency means less than a predetermined threshold, such as “appearance rate <20%” at a certain appearance position, for example. The motion word frequency analyzing unit 14 may determine whether or not the frequency is low from the appearance rate of a motion word in the entire motion word string regardless of the appearance position. For example, in the example illustrated in the upper drawing of FIG. 4, it is determined that a motion word “lower the arm” is infrequent. Moreover, it is assumed that a motion word determined to be infrequent as described above is a motion word that is not very meaningful.

Further, the motion word frequency analyzing unit 14 determines whether or not the appearance frequency of a motion word is high, as an example of analysis. Here, it is assumed that high frequency means equal to or more than a predetermined threshold, such as “appearance rate ≥80%” at a certain appearance position, for example. The motion word frequency analyzing unit 14 may determine whether or not the frequency is high from the appearance rate of a motion word in the entire motion word string regardless of the appearance position. It should be noted that a motion word that frequently appears in a specific appearance position, as described above, is assumed to be a meaningful and important word that characterizes the corresponding higher-level motion. In that case, it is determined whether there is a pattern where there are multiple important words and their appearance positions are switched. On the other hand, it is assumed that a motion word that appears highly frequently while the appearance position is not specified is a meaningless word that can be ignored as a stop word.

Further, the motion word frequency analyzing unit 14 determines whether or not the vector expression of the motion word itself is close, as an example of analysis. For example, a distance when motion words are in vector expressions is calculated, and the motion words that are close to each other within a threshold are determined to be synonyms.

Further, the motion word frequency analyzing unit 14 may perform the analysis described above in a plurality of motion word units rather than one motion word unit. For example, appearance frequency of two to three consecutive motion words may be determined.

The data deforming unit 15 (deforming unit) deforms the motion word string Vword of the new motion data V in accordance with the analysis result by the motion word frequency analysis unit 14 described above, and generates augmented data Vword′ that is a new motion word string. To be specific, as a result of comparison between the motion word strings Xwords as described above, the data deforming unit 15 assumes that the motion words that are determined to appear infrequently are motion words that are not very meaningful, thus it is considered unlikely to affect the motion recognition of the original new motion data even if they are added or deleted from the motion word strings Vwords. Therefore, the data deforming unit considers the motion words determined to appear infrequently as noise, and generates new augmented data Vword′ in which the motion word is added or deleted from the motion word string Vword as data to which the same motion recognition label as the original motion word string Vword is applied. For example, in the example of FIG. 4, in the case where it is determined that a motion word “lower the arm” is infrequent among the motion words in the motion data set X, the motion word “lower the arm” is added to the motion word string Vword of the new motion data V to generate new data, or the motion word “lower the arm” is deleted from the motion word string Vword of the new operation data V to generate new data, and is used as the augmented data Vword′.

Further, as a result of comparison between the motion word strings Xwords, the data deforming unit 15 assumes that a motion word whose appearance frequency at a specific appearance position is determined to be high is important, so that it is considered unlikely to have an influence even if a part of the motion word string Xword is deleted from the motion word string Vword. Therefore, the data deforming unit 15 generates the augmented data Vword′ by replacing a part of the motion word, such as a half of the motion word that is determined to appear frequently at a specific appearance position, with another motion word in the motion word string Vword. At this time, in the case where there are a plurality of important motion words and there is a pattern in which the appearance positions are switched, the data deforming unit 15 generates the augmented data Vword′ by switching the appearance positions of the motion words in the motion word string Vword. Further, for the motion word determined to be highly frequently regardless of the appearance position, it is assumed that it is a meaningless word that can be ignored as a stop word. Therefore, the data deforming unit 15 considers such motion word as noise and generates the augmented data Vword′ by adding or deleting it to or from the motion word string Vword.

Moreover, in the case where there is a synonym with a similar vector expression of the motion word itself as a result of the analysis described above, the data deforming unit 15 substitutes the motion word in the motion word string Vword with the synonym, and generates the augmented data Vword′.

The data deforming unit 15 may perform the process of deleting, adding, and changing motion words with respect to the motion word string Vword as described above, in units of two to three consecutive motion words.

As described above, the data deforming unit 15 can generate the augmented data Vword′ to increase the number of pieces of data without changing the essence of the data content, by adding or deleting motion words that are considered to be noise, replacing a part of important motion words, or replacing motion words with synonyms, with respect to the motion word string of the new operation data V. For example, in the example of the motion word string of the new motion data V illustrated in the lower drawing of FIG. 4, the number of pieces of the augmented data Vword′ can be increased without changing the essence of the data. The generated augmented data Vword′ can be associated with the original higher-level motion label “posture change” of the original new motion data V, and can be used as training data for machine-learning the motion recognition model that recognizes the higher-level motion.

Note that the data deforming unit 15 may output the augmented data Vword′ generated as described above to be displayed on the screen of the operation terminal 20. In accordance with it, the operation terminal 20 receives input of suitability from the operator for the displayed augmented data Vword′. At this time, for example, the operator of the operation terminal 20 checks the content of the motion word string that is the displayed augmented data Vword′, that is, the meaning of the sentence by the motion word string as illustrated in FIG. 4, inputs that it is applicable when the content is consistent with the higher-level motion, and inputs that it is not applicable when it is inconsistent. Then, the data deforming unit 15 selects the motion word string for which an input that it is applicable is received from the operation terminal 20 as the augmented data Vword′, and allows it to be the learning data.

### [Operation]

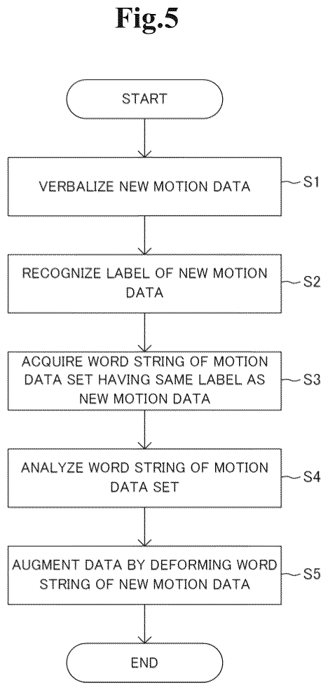

Next, processing operation by the data augmentation apparatus 10 will be described. First, the data augmentation apparatus 10 acquires the new motion data V, and transforms it into a “motion word string Vword” including a sequence of a series of “motion words” (step S1 of FIG. 5). For example, as illustrated in the lower drawing of FIG. 4, the new motion data V is transformed into a “motion word string Vword” including a sequence of “motion words” such as [“turn the palm up”, “raise the arm”, . . . ].

In addition, the data augmentation apparatus 10 may acquire a label motion data set X with the higher-level motion label Y given, and transform it into a “motion word string Xword” including a sequence of a series of “motion words”. Consequently, for example, as illustrated in the upper drawing of FIG. 4, respective pieces of motion data of the motion data set X is transformed into “motion word strings Xwords” each including a sequence of “motion words” such as [“turn the palm up”, “raise the arm”, . . . ], . . . , and [“raise the arm”, “lower the arm”, . . . ]. Then, these motion word strings Xwords are stored in association with the higher-level motion label Y of the higher-level motion “getting up assistance”. However, the data augmentation apparatus 10 may transform the motion data set X into the motion word string Xword at any timing and store it, and may acquire the motion word string Xword that has already been transformed and stored in a predetermined storage device.

Then, the data augmentation apparatus 10 recognizes a higher-level motion of the new operation data V from the motion word string Vword transformed from the new motion data V, and outputs a higher-level motion label that is the inference result Wp (step S2 of FIG. 5). For example, in the example illustrated in the lower drawing of FIG. 4, the new motion data V corresponds to a higher-level motion “posture change”, but in a situation where such a higher-level motion has not been machine-learned, it is assumed that the motion word string Vword of the new motion data V is recognized as a higher-level motion “getting up assistance”.

Then, the data augmentation apparatus 10 acquires the motion word string Xword of the motion data set X corresponding to a higher-level motion label Y identical to the higher-level motion label that is the inference result Wp of the new motion data V (step S3 of FIG. 5). For example, in the example illustrated in FIG. 4, since the new motion data V is recognized as the higher-level motion “getting up assistance”, a plurality of motion word strings Xwords associated with the same higher-level motion label Y “getting up assistance” are extracted.

Then, the data augmentation apparatus 10 compares and analyzes the extracted motion word strings Xwords (step S4 of FIG. 5). For example, the data augmentation apparatus 10 calculates the appearance position and the appearance frequency of a specific motion word in the motion word string Xword. Then, the data augmentation apparatus 10 generates the augmented data Vword′ in which the motion word string of the new motion data V is deformed in accordance with the analysis result such as appearance frequency of the motion word (step S5 of FIG. 5). As an example, in the case where it is determined that the motion word “lower the arm” is infrequent in the example illustrated in the upper drawing of FIG. 4, such motion word is regarded as noise, and new augmented data Vword′ in which addition or deletion is made in the motion word string Vword is generated. As described above, the data augmentation apparatus 10 also performs various types of data deformation in accordance with the analysis results.

As described above, the data augmentation apparatus 10 increases the number of pieces of data by applying various types of deformation to the motion word string of the new motion data V. Consequently, the motion word string corresponding to the higher-level motion of the new motion data V can be increased, and the training data to be used for machine learning of the motion recognition model that recognizes higher-level motions can be increased. As a result, the motion recognition model can be machine-learned with high accuracy, and the motion of a person can be recognized correctly.

In particular, the data augmentation apparatus 10 performs data augmentation by deforming the motion word string of the new motion data V in accordance with the analysis result such as the appearance frequency of the motion word in the motion word string of the motion data set X corresponding to the higher-level motion in which the motion word string of the new motion data V is recognized. For example, by adding or deleting motion words that are determined to be noise or stop words as a result of analysis, it is possible to perform data augmentation by transforming the motion word string while suppressing the effect on the motion recognition without changing the essence of the data.

Moreover, in the present disclosure, as an example, it is possible to generate training data that can be used for machine-learning the motion recognition model for recognizing implementation of nursing motions by a nurse. As a result, the accuracy of the motion recognition model can be improved, and decision-making for treatment by the medicalcare professionals such as nurses and doctors with respect to the recognized nursing motions can be supported.

However, as described above, the higher-level motions that can be recognized as motions are not limited to the nursing motions by the nurses described above, are not limited to the motions in the field of medicalcare and healthcare, and may be any motions. In relation to this, the basic motions constituting the higher-level motions are not limited to the basic motions described above, and may be any motions.

### Second Example Embodiment

Next, a second example embodiment of the present disclosure will be described with reference to the drawings. In the present embodiment, overview of the data augmentation apparatus and the like described in the above example embodiment is illustrated. The drawings may be associated in any embodiments.

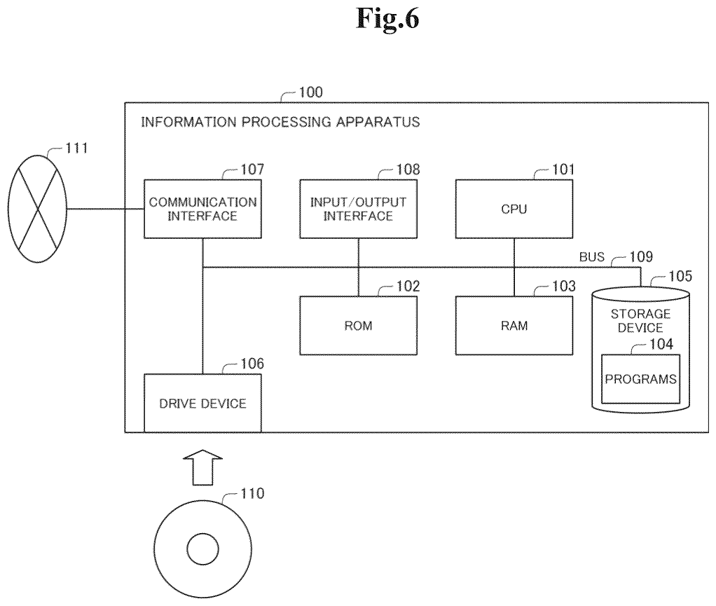

First, a hardware configuration of an information processing apparatus 100 in the present disclosure will be described. The information processing apparatus 100 is configured of a general information processing apparatus, and as an example, as illustrated in FIG. 6, it is equipped with the following hardware configuration:
a CPU (Central Processing Unit) 101 (arithmetic logic unit);
a ROM (Read Only Memory) 102 (storage device);
a RAM (Random Access Memory) 103 (storage device);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 6 illustrates an example of hardware configuration of an information processing apparatus serving as the information processing apparatus 100, and the hardware configuration of the information processing apparatus is not limited to the aforementioned case. For example, the information processing apparatus may be configured of part of the aforementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the aforementioned CPU.

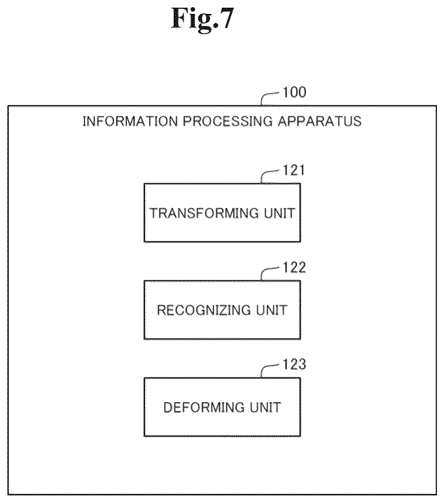

The information processing apparatus 100 can construct and include a transforming unit 121, a recognizing unit 122, and a deforming unit 123 illustrated in FIG. 7 by the CPU 101 acquiring and executing the programs 104. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs 104 may be stored in advance in the storage medium 110 and read out by the drive device 106 and provided to the CPU 101. However, the transforming unit 121, the recognizing unit 122, and the deforming unit 123 described above may be constructed using dedicated electronic circuits for realizing such means.

The transforming unit 121 transforms first motion data into a first symbol string including a sequence of symbols. The recognizing unit 122 recognizes the motion of the first motion data on the basis of the first symbol string. The deforming unit 123 generates a third symbol string in which the first symbol string is deformed based on a second symbol string in which second motion data corresponding to the motion in which the first motion data is recognized is transformed into a sequence of symbols.

With the configuration as described above, in the present disclosure, when new first motion data is acquired, the symbol string of the first motion data can be deformed and generated as the third motion data by using the symbol string of the second motion data that can correspond to the first motion data. Consequently, the symbol string of the first motion data corresponding to the new motion can be deformed and augmented, and can be used as training data of the motion recognition model that recognizes the new motion. As a result, machine learning of the motion recognition model enables the motion of a person to be recognized appropriately by the motion recognition model.

Note that at least one or more functions of the transforming unit 121, the recognizing unit 122, and the deforming unit 123 may be performed by an information processing apparatus installed and connected anywhere on the network, that is to say, may be performed by so-called cloud computing.

In addition, the aforementioned programs can be stored using various types of non-transitory computer-readable media and provided to a computer. Non-transitory computer-readable media include various types of tangible storage media. Examples of non-transitory computer-readable media include magnetic recording media (e.g., flexible disk, magnetic tape, hard disk drive), magneto-optical recording media (e.g., magneto-optical disk), CD-ROM (read only memory), CD-R, CD-R/W, and semiconductor memories (e.g., mask ROM, programmable ROM, Erasable PROM, flash ROM, RAM (random access memory)). In addition, a program may be provided to a computer by various types of transitory computer-readable media. Examples of transitory computer-readable media include electrical signals, optical signals, and electromagnetic waves. A transitory computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Each example embodiment described above can be appropriately combined with the other embodiments.

### Supplementary Note

The whole or part of the example embodiments disclosed above can be described as the following supplementary notes. Hereinafter, overview of the configurations of the information processing apparatus, the information processing method, and the program in the present disclosure will be described. However, the present disclosure is not limited to the configurations described in the following supplementary notes.

Note that some or all of the configurations described in Supplementary Notes 2 to 8.2 dependent on Supplementary Note 1 described above and the functions resulting from such configurations may be dependent on other Supplementary Notes 9 and 10 by the same dependence as Supplementary Notes 2 to 8.2. Furthermore, not limited to Supplementary Notes 1, 9, and 10, within the scope of the respective example embodiments described above, some or all of the configurations described as supplementary notes and functions according to such configurations may be dependent with respect to various hardware, software, various recording means for recording software, or systems.

### (Supplementary Note 1)

An information processing apparatus comprising:
a transforming unit that transforms first motion data into a first symbol string including a sequence of symbols;
a recognizing unit that recognizes a motion of the first motion data based on the first symbol string; and
a deforming unit that generates a third symbol string in which the first symbol string is deformed based on a second symbol string, the second symbol string being a string in which second motion data corresponding to the motion recognized in the first motion data is transformed into a sequence of symbols.

### (Supplementary Note 2)

The information processing apparatus according to Supplementary Note 1, wherein
the deforming unit generates the third symbol string in which a part of the first symbol string is deformed based on a part of the second symbol string.

### (Supplementary Note 3)

The information processing apparatus according to Supplementary Note 2, wherein
the deforming unit generates the third symbol string in which a symbol included in the second symbol string is added to or deleted from the first symbol string.

### (Supplementary Note 3.1)

The information processing apparatus according to Supplementary Note 2, wherein
the deforming unit generates the third symbol string in which a symbol similar to a symbol included in the second symbol string according to a preset criterion is added to or deleted from the first symbol string.

### (Supplementary Note 4)

The information processing apparatus according to Supplementary Note 1, wherein
the deforming unit generates the third symbol string in which the first symbol string is deformed based on comparison between a plurality of the second symbol strings in which a plurality of pieces of the second motion data are transformed.

### (Supplementary Note 5)

The information processing apparatus according to Supplementary Note 4, wherein
the deforming unit generates the third symbol string in which the first symbol string is deformed based on an appearance frequency of a predetermined symbol in the plurality of second symbol strings.

### (Supplementary Note 6)

The information processing apparatus according to Supplementary Note 5, wherein
the deforming unit generates the third symbol string in which a symbol having an appearance frequency that is lower than a preset criterion in the plurality of second symbol strings is added to or deleted from the first symbol string.

### (Supplementary Note 6.1)

The information processing apparatus according to Supplementary Note 5, wherein
the deforming unit generates the third symbol string in which a symbol having an appearance frequency that is higher than a preset criterion in the plurality of second symbol strings is added to or deleted from the first symbol string.

### (Supplementary Note 6.2)

The information processing apparatus according to Supplementary Note 4, wherein
the deforming unit generates the third symbol string in which the first symbol string is deformed based on an appearance position of a predetermined symbol in the plurality of second symbol strings.

### (Supplementary Note 7)

The information processing apparatus according to Supplementary Note 4, wherein
the deforming unit generates the third symbol string in which the first symbol string is deformed based on an appearance position and an appearance frequency of a predetermined symbol in the plurality of second symbol strings.

### (Supplementary Note 7.1)

The information processing apparatus according to Supplementary Note 7, wherein
the deforming unit generates the third symbol string in which a symbol having an appearance position that is same in the plurality of second symbol strings and having an appearance frequency that is higher than a preset criterion is added to or deleted from the first symbol string.

### (Supplementary Note 8)

The information processing apparatus according to Supplementary Note 1, wherein
the recognizing unit recognizes the motion of the first motion data from the first symbol string by using a machine learning model.

### (Supplementary Note 8.1)

The information processing apparatus according to Supplementary Note 1, wherein
each of symbols in a sequence included in a symbol string includes one symbol or a symbol group including a plurality of symbols.

### (Supplementary Note 8.2)

The information processing apparatus according to supplementary Note 1, wherein
each of symbols in a sequence included in a symbol string includes a plurality of characters.

### (Supplementary Note 9)

An information processing method comprising:
transforming first motion data into a first symbol string including a sequence of symbols;
recognizing a motion of the first motion data based on the first symbol string; and
generating a third symbol string in which the first symbol string is deformed based on a second symbol string, the second symbol string being a string in which second motion data corresponding to the motion recognized in the first motion data is transformed into a sequence of symbols.

### (Supplementary Note 10)

A program for causing a computer to execute processing to:
transform first motion data into a first symbol string including a sequence of symbols;
recognize a motion of the first motion data based on the first symbol string; and
generate a third symbol string in which the first symbol string is deformed based on a second symbol string, the second symbol string being a string in which second motion data corresponding to the motion recognized in the first motion data is transformed into a sequence of symbols.

### REFERENCE SIGNS LIST

10 data augmentation apparatus
11 motion verbalizing unit
12 higher-level motion recognizing unit
13 data extracting unit
14 motion word frequency analyzing unit
15 data deforming unit
20 operation terminal
100 information processing apparatus
101 CPU
102 ROM
103 RAM
104 programs
105 storage device
106 drive device
107 communication interface
108 input/output interface
109 bus
110 storage medium
111 communication network
121 transforming unit
122 recognizing unit
123 deforming unit

1. An information processing apparatus comprising:
at least one memory configured to store processing instructions; and
at least one processor configured to execute processing instructions to:
transform first motion data into a first symbol string including a sequence of symbols;
recognize a motion of the first motion data based on the first symbol string; and
generate a third symbol string in which the first symbol string is deformed based on a second symbol string, the second symbol string being a string in which second motion data corresponding to the motion recognized in the first motion data is transformed into a sequence of symbols.

2. The information processing apparatus according to claim 1, wherein the at least one processor is configured to execute the processing instructions to
generate the third symbol string in which a part of the first symbol string is deformed based on a part of the second symbol string.

3. The information processing apparatus according to claim 2, wherein the at least one processor is configured to execute the processing instructions to
generate the third symbol string in which a symbol included in the second symbol string is added to or deleted from the first symbol string.

4. The information processing apparatus according to claim 2, wherein the at least one processor is configured to execute the processing instructions to
generate the third symbol string in which a symbol similar to a symbol included in the second symbol string according to a preset criterion is added to or deleted from the first symbol string.

5. The information processing apparatus according to claim 1, wherein the at least one processor is configured to execute the processing instructions to
generate the third symbol string in which the first symbol string is deformed based on comparison between a plurality of the second symbol strings in which a plurality of pieces of the second motion data are transformed.

6. The information processing apparatus according to claim 5, wherein the at least one processor is configured to execute the processing instructions to
generate the third symbol string in which the first symbol string is deformed based on an appearance frequency of a predetermined symbol in the plurality of second symbol strings.

7. The information processing apparatus according to claim 6, wherein the at least one processor is configured to execute the processing instructions to
generate the third symbol string in which a symbol having an appearance frequency that is lower than a preset criterion in the plurality of second symbol strings is added to or deleted from the first symbol string.

8. The information processing apparatus according to claim 6, wherein the at least one processor is configured to execute the processing instructions to
generate the third symbol string in which a symbol having an appearance frequency that is higher than a preset criterion in the plurality of second symbol strings is added to or deleted from the first symbol string.

9. The information processing apparatus according to claim 5, wherein the at least one processor is configured to execute the processing instructions to
generate the third symbol string in which the first symbol string is deformed based on an appearance position of a predetermined symbol in the plurality of second symbol strings.

10. The information processing apparatus according to claim 5, wherein the at least one processor is configured to execute the processing instructions to
generate the third symbol string in which the first symbol string is deformed based on an appearance position and an appearance frequency of a predetermined symbol in the plurality of second symbol strings.

11. The information processing apparatus according to claim 10, wherein the at least one processor is configured to execute the processing instructions to
generate the third symbol string in which a symbol having an appearance position that is same in the plurality of second symbol strings and having an appearance frequency that is higher than a preset criterion is added to or deleted from the first symbol string.

12. The information processing apparatus according to claim 1, wherein the at least one processor is configured to execute the processing instructions to
recognize the motion of the first motion data from the first symbol string by using a machine learning model.

13. The information processing apparatus according to claim 1, wherein
each of symbols in a sequence included in a symbol string includes one symbol or a symbol group including a plurality of symbols.

14. The information processing apparatus according to claim 1, wherein
each of symbols in a sequence included in a symbol string includes a plurality of characters.

15. An information processing method comprising:
transforming first motion data into a first symbol string including a sequence of symbols;
recognizing a motion of the first motion data based on the first symbol string; and
generating a third symbol string in which the first symbol string is deformed based on a second symbol string, the second symbol string being a string in which second motion data corresponding to the motion recognized in the first motion data is transformed into a sequence of symbols.

16. A non-transitory computer-readable medium storing thereon a program comprising instructions for causing a computer to execute processing to:
transform first motion data into a first symbol string including a sequence of symbols;
recognize a motion of the first motion data based on the first symbol string; and
generate a third symbol string in which the first symbol string is deformed based on a second symbol string, the second symbol string being a string in which second motion data corresponding to the motion recognized in the first motion data is transformed into a sequence of symbols.
